(19) United States
(12) Patent Application Publication
(10) Pub. No.: US 2014/0347680 A1
(43) Pub. Date: Nov. 27, 2014

(54) Methods and Systems for Printing an Image on an Article

(71) Applicant: Casetagram Limited, Hong Kong (HK)

(72) Inventor: Pui-Sun Wesley NG, Hong Kong (HK)

(73) Assignee: Casetagram Limited, Hong Kong (HK)

(21) Appl. No.: 13/900,650

(22) Filed: May 23, 2013

(51) Int. Cl. G06F 3/12

(52) U.S. Cl. CPC G06F 3/1208; G06F 3/125
USPC 358/1.9; 358/1.18

(57) ABSTRACT

Systems and methods are provided for creating a print image using a computer processing system. The print image is then printed on an article. The methods include retrieving layouts and images, prompting a user to select a layout and images for placement in at least one bounded area; and sending layout, image, and placement information to a print server for creating a print image. The print server is connected to a printer for printing the print image on an article.

### FIELD OF THE INVENTION

The present invention relates to a method of generating an image to be printed on an article. More specifically, the present invention relates to a method of creating a new image to be printed on an article by using a plurality of images and a layout retrieved from a server.

### BACKGROUND OF THE INVENTION

Images, such as photographs and drawings, are very commonly used to maintain memories and events that formed a part of a person's life. At the same time, articles, such as T-shirts, handbags, cellular phones, tablets, and laptops, are common articles that people bring along when they travel and commute. People like to print images on an article to remind themselves or to share with others about the memories and events. As a person may want to show multiple images on the article, it is time consuming to organize the images and then print the images on article. The common manner of organizing these images within the prior art is to place the images into either an album or a box. Creative people often spend hours carefully selecting and arranging photos.

Prior art disclosures as represented by U.S. Pat. No. 6,123,362 have taught the creation of photo albums wherein individual pages are created as a photo collage from stickers. However, this prior art disclosure did not provide any methodology whereby the layout of the photo collage is retrieved from a server, and the photo collage to be created can be printed on an article.

### SUMMARY OF THE INVENTION

The present invention addresses the foregoing discussed shortcomings in the prior art by providing a method creating a print image wherein the print image is created from a plurality of images retrieved from at least one image server, based on a layout retrieved from a print server. Then the print image is printed on an article. Each of the plurality of images has a low resolution version and a high resolution version that can be retrieved from at least one image server.

A user first chooses at least one image and one layout, and then places the selected image(s) on the selected layout. Information of the selected image(s), the selected layout and placement information are then sent to the print server. The print server then retrieves high resolution versions of the selected image(s) from the at least one image server to create one print image according to the layout and placement information. The print image is then printed on an article.

Each layout retrieved from the print server is composed of a plurality of bounded areas. A bound area can be a circle, triangle, square, rectangle, or any shape that an image can be put on.

### BRIEF DESCRIPTION OF THE DRAWINGS

FIG. 1 is a block diagram showing the system elements to generate the print image useful for practicing the present invention.

FIG. 2 is a system diagram showing a digital image print system with a print server envisioned by the present invention.

FIG. 3 is a flowchart of the process by which an image is prepared for the print server of FIG. 2.

FIG. 4 is a flowchart of the process by which the print server of FIG. 2 prints an image on an article without a particular color.

FIG. 5 is an illustration showing an article printed with a print image.

FIG. 6 is an illustration showing six exemplary layouts with different bounded areas.

FIG. 7 is an illustration showing a block diagram of a print server.

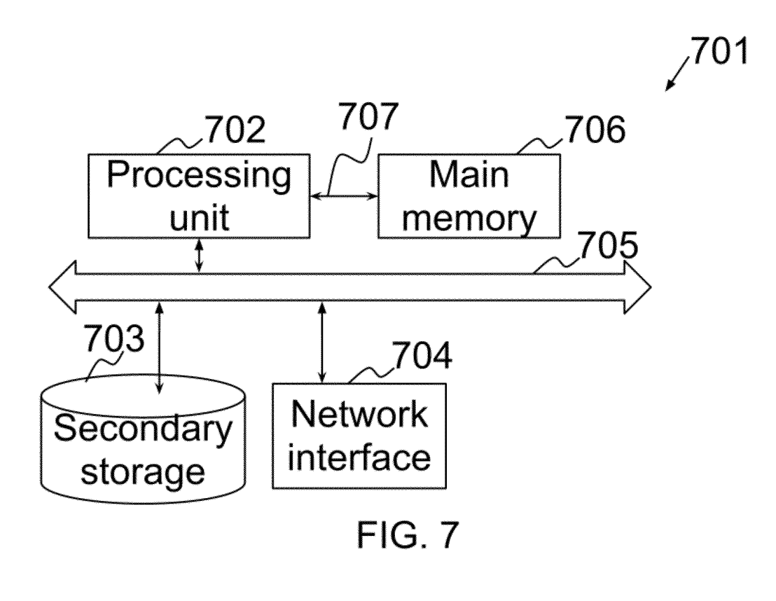

### DETAILED DESCRIPTION

The ensuing description provides exemplary embodiment(s) only, and is not intended to limit the scope, applicability or configuration of the invention. Rather, the ensuing description of the exemplary embodiment(s) will provide those skilled in the art with an enabling description for implementing an exemplary embodiment of the invention. It is understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices, and/or other machine readable mediums for storing information. The term “machine-readable medium” includes, but is not limited to, portable or fixed storage devices, optical storage devices, wireless channels, and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processing unit(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

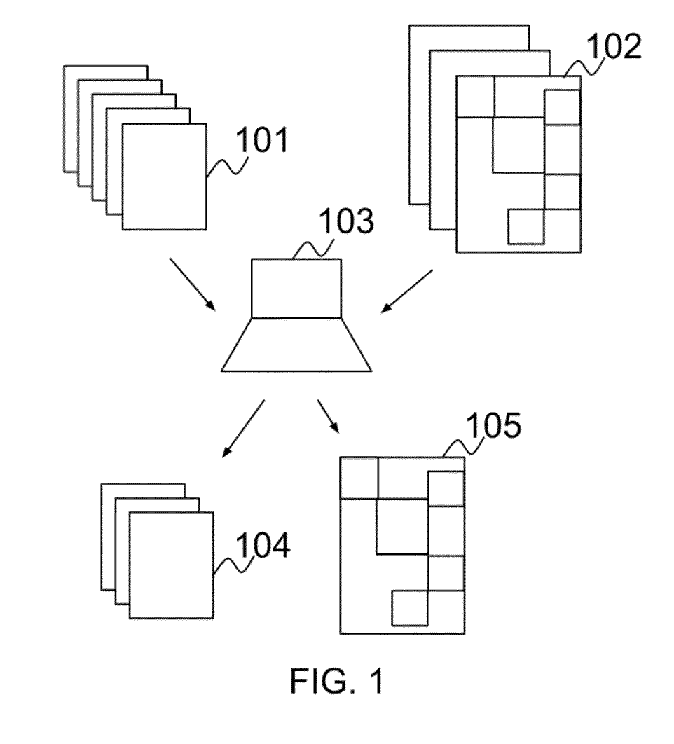

FIG. 1 is a block diagram showing the basic system elements to generate the print image useful for practicing one of the embodiments of the present invention. The system elements include images 101, layouts 102, electronic device 103, selected image(s) 104, and selected layout 105. A user uses electronic device 103 to select at least one image from images 101 and selected layout 105 from layouts 102. The selected image is selected image(s) 104. Electronic device 103 can be any electronic device, such as mobile phone, computer, laptop and tablet, that has input circuit to allow the user to select and communication circuits to retrieve and send digital data. In addition to selecting images and a layout, the user uses electronic device 103 to determine how the selected image(s) 104 are placed in the selected layout 105. When the user has selected the selected image(s) 104, selected layout 105, the electronic device creates selection information. The selection information includes information corresponding to the selected image(s) 104, selected layout 105, and the information of how selected image(s) 104 is placed in selected layout 105. Also when the user has determined how the selected image(s) 104 are placed in selected layout 105, the electronic device creates placement information.

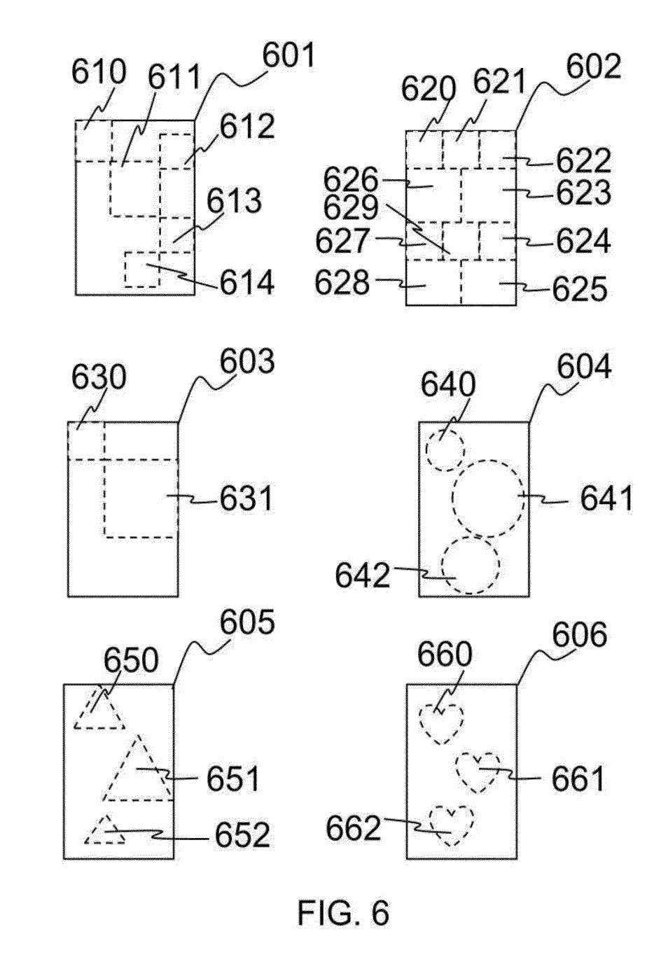

Each layout of layouts 102 is composed of bounded areas. The bounded areas are for the user to place the selected image(s) 104. FIG. 6 illustrates six exemplary layouts of layouts 102 for practicing one of the embodiments of the present invention. First layout 601 is composed of five bounded squares 610, 611, 612, 613, and 614. A user may place five selected images 104 in these five bounded squares. Second layout 602 is composed of ten bounded squares 620, 621, 622, 623, 624, 625, 626, 627, 628, and 629. Third layout 603 is composed of two bounded squares 630 and 631. Fourth layout 604 is composed of three bounded circles 640, 641 and 642. Fifth layout 605 is composed of three bounded triangles 650, 651 and 652. Sixth layout 606 is composed of three bounded hearts 660, 661 and 662. These exemplary layouts illustrate that the bounded areas can be in any shape, the corresponding positions of the bounded areas, the number of bounded areas, and the number of layouts are not limited. The examples do not stipulate a universal set of layouts that can be implemented by the present invention.

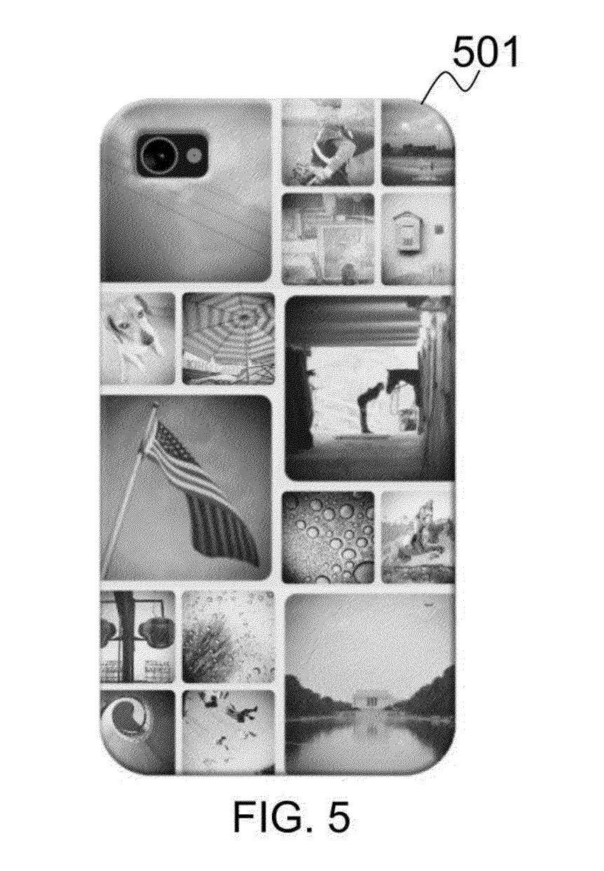

Article 501 in FIG. 5 illustrates the results of printing a print image on an article, which is a case for iPhone in that example.

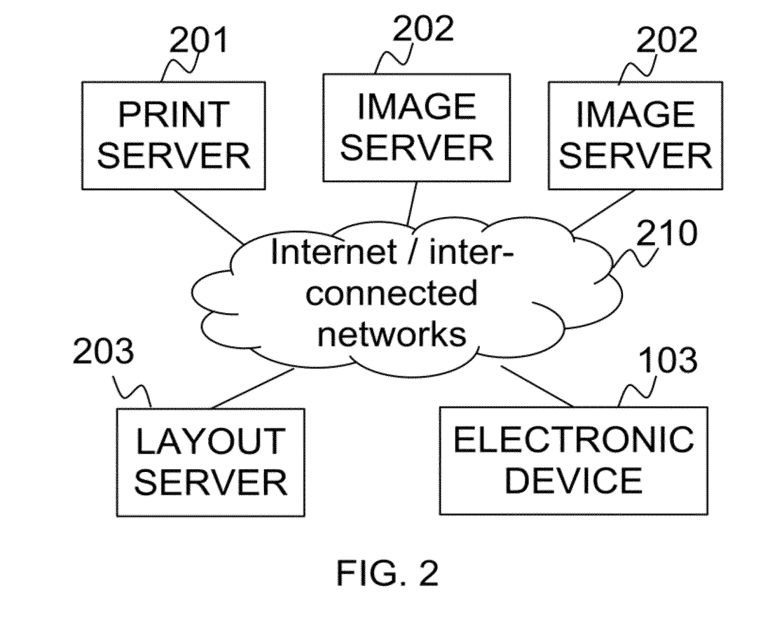

FIG. 2 is a system diagram showing a digital image print system with a print server for practicing one of the embodiments of the present invention, viewed in conjunction with FIG. 1. User's electronic device 103 retrieves images 101 from at least one image server 202 through the Internet or network 210. User's electronic device 103 also retrieves layouts 102 from layout server 203 through the Internet or network 210. When the user has selected selected image(s) 104 and selected layout 105 and has determined how selected image(s) 104 are placed in the selected layout 105, electronic device 103 creates placement information and sends the selection information and placement information to print server 201 through the Internet or network 210. Print server 201 then retrieves higher resolution version of selected image(s) 104 from at least one image server 202 to create a print image according to information received from electronic devices 103. The print image will then be printed on an article. In one variant, print server 201 does not provide the plurality of layouts. A separate layout server 203 is used to provide the plurality of layouts through the Internet or network 210. Image server 202 can be any device capable of providing images, including a cloud server, a mobile phone, a laptop computer, a router with image storage capability and etc.

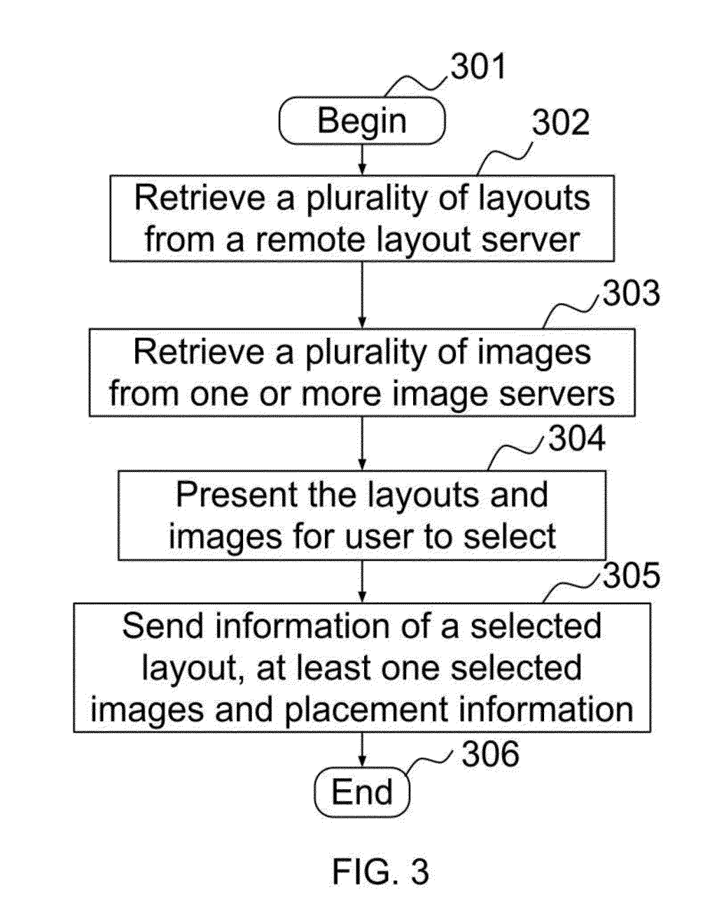

FIG. 3 is a process diagram illustrating one of the embodiments of the present invention at the user's electronic device. The process commences at step 301. User's electronic device 103 retrieves a plurality of layouts from a print server at step 302. User's electronic device 103 then retrieves a plurality of images from at least one image server at step 303 and presents the layouts and images retrieved for the user to select at step 304. Therefore, the user is prompted to select at least one layout from the presented layouts and at least one image from the presented images. The user is able to place photos in the layouts. The identity of photos and locations of photos placed in a layout is referred to as placement information. If there is no photo being placed in a layout, there is no placement. Placement information should contain the identity of at least one selected image, and the location of the at least one selected image in the selected layout. When the user has determined the selected image(s) 104, selected layout 105 and placement information of how the selected image(s) 104 are placed in the selected layout 105, the selected image(s) information, selected layout information and placement information are then sent to the print server 201 at step 305.

According to one of the embodiments of the present invention, at step 303, the images retrieved from the at least one image server include two groups of images. The first group of images is created by the user. The second group of images is not created by the user and the user is not allowed to select and use these images for printing. In one variant, the selection of the second group of images at step 304 requires consideration. Consideration can be in the form of monetary consideration, a payment, an endorsement, a signing up, a legal tender, an agreement, and comments. In one variant, the printing of the second group of images requires consideration. In one variant, a user is allowed to use images retrieved from both groups of images for printing.

In another variant, a user is allowed to mix images retrieved only from both groups of images for printing. In another variant, both groups of images are stored in the same image server. In another variant, both groups of images are stored in different image servers.

According to one of the embodiments of the present invention, at step 303, the images retrieved are low resolution version of the images stored at the image server. The use of low resolution images is to reduce the bandwidth requirement and results in faster retrieval of the lower resolution images from the image server.

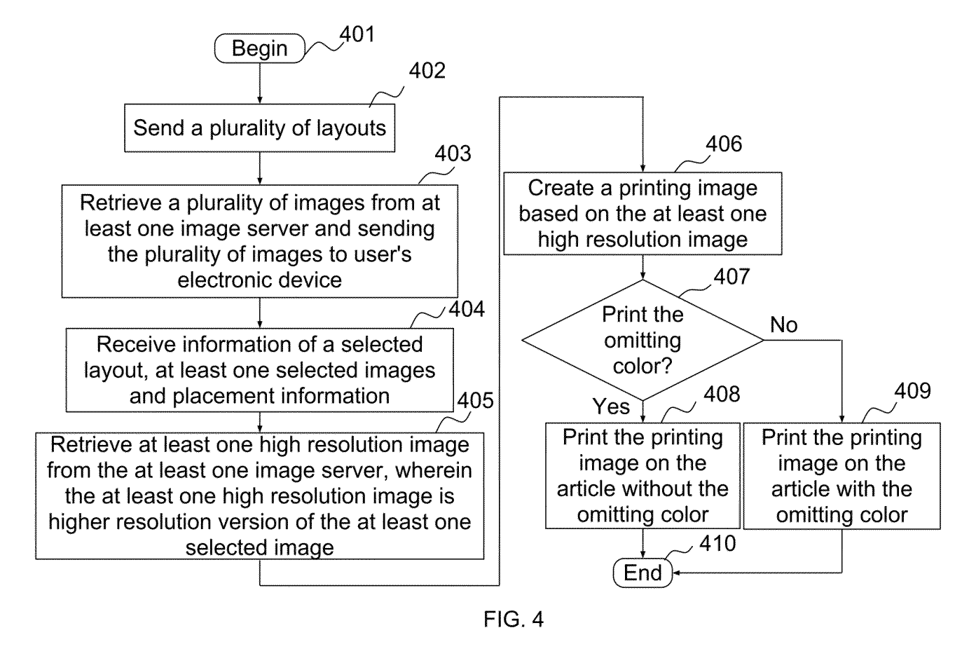

FIG. 4 is a process diagram illustrating one of the embodiments of the present invention at the print server. The process commences at step 401. At step 402, print server sends a plurality of layouts to a user's electronic device through the Internet or network. At step 403, the print server retrieves a plurality of images from at least one image server through the Internet or network and then sends the retrieved plurality of images to the user's electronic device through the Internet or network for the user to select. When a user has finalized the selection of selected image(s) 104, selected layout 105, and placement information of how selected image(s) 104 are placed in the selected layout 105, the user's electronic device sends selected layout information and placement information to print server 201 through the Internet or network at step 404. At step 405, print server retrieves high resolution version(s) of the selected image(s) 104 from the at least one image server through the Internet or network.

For example, if the user has selected seven selected images from first image servers and another selected image from a second image server, the print server retrieves seven high resolution version images of the seven selected images from the first server and one high resolution version image of the one selected image from the second server. At step 406, the print server creates one print image based on the high resolution version images of the selected images, selected layout, and placement information. At step 407, the print server determines whether to omit an omitting color in the print image when printing the print image on the print article. The omitting color is a color that is similar to the background color of the print article. When it is decided to omit the color, the print image is printed on the article without the omitting color at step 408. On the other hand, if it is decided to print the printing image with the omitting color on the print article, the omitting color is not omitted from printing at step 409. The omitting color need not to be identical to the background color of the article. For example, if the background color of the print article is black, the omitting color can be black or any color close to black. The reason for not printing the omitting color is to use the background color of the print article. As it is difficult to print a color that is identical to another color, using the background color as the omitting color not only saves raw printing material, such as ink, but also allows for a better appearance of the color. In one variant, the omitting color is selected automatically by finding a color that is identical to the background color of the article. In another variant, the omitting color is selected automatically by finding a color that is close to the background color of the article within a pre-defined tolerance. For example, the red-green-blue color value is within five percentage of the background color. In another variant, the omitting color is selected manually by the administrator of the print server. The process ends at step 410.

The print image is printed onto an article by a printer, which is connected to the print server through a communication technology. The article can be any object, such as a toy, a sticker, apparel, T-shirts, a jacket, a pair of trousers, a fashion accessory, a bracelet, a necklace, a handbag, a case for electronic device, mobile phone case, a mobile phone sticker, a tablet case, a laptop case, a cup, a plate, a cutlery, an umbrella, and a tumbler. The preferred articles that are used to be printed with the print images printer are common articles that people bring along when they travel and commute, such as iPhone, iPad, Samsung smartphone, Samsung Galaxy smartphones, Samsung Galaxy tables, Google Nexus smartphones and Google Nexus tablets.

According to one of the embodiments of the present invention, selected images 104 are transformed, cropped and resized to fit bounded areas. Using layout 605 as an example, when the user selects a first selected image and places the first selected image at bounded triangle 650, the first selected image is resized and cropped to fit bounded triangle 650. Similarly, when the user selects a second selected image and a third selected image and places them at bounded triangle 651 and 652 respectively, the second and third selected images are resized and cropped to fit bounded triangles 651 and 652. According to one of the embodiments of the present invention, when a user drags selected image 104 over a bounded area of a layout at the electronic device, the instruction codes running at the electronic device fits the image(s) to the bounded area by performing image processing on the image(s) automatically. The image processing operation includes transforming, cropping and resizing. When the user has selected selected images 104, selected layout 105, and placed selected images 104 in the bounded areas of selected layout 105, and finalized the selections and placement, the electronic device then sends the information of selected images 104, selected layout 105 and placement information to print server 201 located remotely.

According to one of the embodiments of the present invention, the transforming, cropping and placement of images fit bounded areas is realized by using HTML5 and Javascript when the invention is embodied by Web technologies and accessed in a web browser. In another variant, the invention can also embodied by other forms and accessed with other types of devices, such as when the accessing device is an iPhone, the same imaging operations are then realized by the native programming tool provided by the corresponding electronic device, the iOS operating system and the programming language Objective C and available libraries.

According to one of the embodiments of the present invention, when electronic device 103 retrieves images, the images are retrieved directly from at least one image server 202. According to one of the embodiments of the present invention, when electronic device 103 retrieves images, the images are retrieved from print server 201, which retrieves images from at least one image server 202.

According to one of the embodiments of the present invention, when electronic device 103 retrieves images, the images are retrieved directly from at least one image server 202. The images that are available for selecting are from two groups. The first group of images is created by the user. The second group of images is not created by the user but the user is not allowed to select and use these images for printing. In one variant, the use of the second group of images requires consideration. In one variant, a user is allowed to use images retrieved from both groups of images for printing. In another variant, a user is allowed to mix images retrieved only from both groups of images for printing. In another variant, both groups of images are stored in the same image server. In another variant, both groups of images are stored in different image servers.

According to one of the embodiments of the present invention, when electronic device 103 retrieves images at step 403, the images retrieved are in a lower resolution than of the original images. This is because using lower resolution images reduces the bandwidth requirement and results in faster retrieval of the lower resolution images. According to one of the embodiments of the present invention, before electronic device 103 retrieves images from the at least one image server, electronic device 103 first sends authentication information to the at least one image server to allow the at least one image server to confirm the identity of the user and the right to retrieve images. The retrieved images are the images that the user has the right to retrieve. For example, if the images are photos taken by the user or user's friends that the user is allowed to retrieve the images, step 403 at FIG. 4 is not performed. It would be apparent to those skilled in the art that there are many methods and techniques to send authentication information, including user identification information, password, hashed password, and digital certificate. According to one of the embodiments of the present invention, when electronic device 103 retrieves images, the authentication information required by the at least one image server are sent to the print server first, then the print server uses the authentication information to retrieve images from the at least one image server. This embodiment allows the print server to present the images to the electronic device in a manner suitable for the print server. According to one of the embodiments of the present invention, when electronic device 103 retrieves images, the authentication is performed with the image server first and the resulting access authorization token is sent to the print server, and then the print server uses the access authorization token to retrieve images from the image server.

Print Server

Print server 701 includes processing unit(s) 702, main memory 706, storage device 703, system bus 705, and network interface 704. Network interface 704 is used to enable print server 701 to communicate with other network apparatus such as Ethernet switches, IP routers and other packet network devices, network management and provisioning systems, local PCs, etc. Other components which may be utilized within print server 701 include amplifiers, board level electronic components, as well as media processors and other specialized SoC or ASIC devices. Main memory 706 may communicate with processing unit(s) 702 using data bus 707 or a different bus. Main memory 706 can, for example, include a random access memory storage device, such as a dynamic random access memory, or other types of computer-readable-medium memory devices. Main memory 706 can be used as a cache to store temporary data, registers, and instructions that are received from the processing unit(s) 702 or the secondary storage 703.

Storage device 703 is used to store data and executable instructions for processing unit(s) 702. Storage device 703 is implemented by using at least one storage medium and is readable by processing unit(s). According to one of the embodiments of present invention, selected images information, selected layout information, and placement information are stored in storage device 703. According to one of the embodiments of present invention, in addition to selected images information, selected layout information, and placement information, omitting color information is also stored in storage device 703.

Processing unit(s) 702 may be implemented by using one or more central processing units, network processors, microprocessors, micro-controllers, FPGAs, ASICs or any device capable of executing instructions to perform the basic arithmetical, logical, and input/output operations of the system. System bus 705 allows processing unit(s) 702, storage device 703, system bus 705 and network interface 704 to send and receive data with each other.

Embodiments, or portions thereof, may be embodied in program or code segments operable upon a system with processing unit(s) (e.g. computer/processing system or computing platform) for performing functions and operations described herein. The program or code segments making up the various embodiments of the present invention may be stored in a computer readable medium or storage medium. The “computer readable medium” and “storage medium” may include any medium that can store information. Examples of the computer readable medium include an electronic circuit, a semiconductor memory device, a ROM, a flash memory, an erasable ROM (EROM), a floppy diskette, a compact disk CD-ROM, an optical disk, a hard disk, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

According to one of the embodiments of the present invention, processing unit(s) 702 sends a plurality of layouts to a user's electronic device through network interface 704 upon receiving a request. Processing unit(s) 702 retrieves a plurality of images from at least one image server through network interface 704 through the Internet or network and then sends the retrieved plurality of images to a user's electronic device through network interface 704 through the Internet or network for the user to select.

In one variant, the plurality of images is cached in storage device 703 temporarily to reduce the need to retrieve the plurality of images from the at least one image server again. In one variant, the plurality of images is low resolution version images of the original images stored in the at least one image server or in a corresponding image server. This is to accelerate the download. In one variant, processing unit(s) 702 does not retrieve the plurality of images from at least one image server through network interface 704. Instead, processing unit(s) 702 sends instructions to the user's electronic device through network interface 704 to allow the user's electronic device to retrieves the plurality of images from at least one image server itself.

When processing unit(s) 702 receives selected image(s) information, selected layout information, and placement information through network interface 704 after the user has finalized the selection of selected image(s) 104, selected layout 105, and placement information of how the selected image(s) 104 are placed in the selected layout 105, processing unit(s) 702 stores selected layout information and placement information in storage device 703. With the selected image(s) information, processing unit(s) 702 retrieves high resolution version images of the selected image(s) from the at least one image server through network interface 704 and stored the high resolution version images in storage device 703.

For example, if processing unit(s) 702 has received selected image(s) information that has five selected images from a first image server and another two selected images from a second image server, processing unit(s) 702 retrieves five high resolution version images of the five selected images from the first server and two high resolution version images of the two selected image from the second server.

Then processing unit(s) 702 creates one print image based on the high resolution version images of the selected images, selected layout, and placement information. The print image is stored at storage device 703. Then processing unit(s) 702 sends the print image to a printer, which is either connected to the print server directly through a port, such as a USB port, serial port, parallel port and infra-red port or indirectly through a network using network interface 704. The printer then prints the print image on the print article. In one variant, the administrator of the print server 701 can also retrieve print image from storage device 703 and operate the printing manually.

According to one of the embodiments of the present invention, processing unit(s) 702 determines whether to omit an omitting color in the print image. The omitting color is a color that is similar to the background color of the print article. When processing unit(s) 702 chose to omit the color, the print image is printed on the print article without the omitting color. On the other hand, if processing unit(s) 702 determines to print the printing image with the omitting color on the print article, processing unit(s) 702 includes the omitting color in the print image. In one variant, the omitting color is selected by processing unit(s) 702 by finding a color that is identical to the background color of the article. In another variant, processing unit(s) 702 selects the omitting color by finding a color that is close to the background color of the article within a pre-defined tolerance. For example, the red-green-blue color is within five percentage of the background color. In another variant, the omitting color is selected manually by the administrator of the print server and received by processing unit(s) 702.

According to one of the embodiments of the present invention, processing unit(s) 702 sends a plurality of layouts to a user's electronic device through network interface 704 upon receiving a request. Processing unit(s) 702 retrieves a plurality of images from at least one image server through network interface 704 through the Internet or network and then sends the retrieved plurality of images to a user's electronic device through network interface 704 through the Internet or network for the user to select. The plurality of images include of two groups of images. The first group of images is created by the user. The second group of images is not created by the user, and the user is not allowed to select and use the images for printing. The printing of the second group of images by the print server at step 304 requires consideration. In one variant, the user is allowed to use images retrieved from both groups of images for printing. In another variant, a user is allowed to mix images retrieved only from both groups of images for printing. In another variant, both groups of images are stored in the same image server. In another variant, both groups of images are stored in different image servers.

Consideration can be in the form of monetary consideration, a payment, an endorsement, a signing up, a legal tender, an agreement and comments.

According to one of the embodiments of the present invention, print server 701 connects to a printer, which is capable of printing the print image on an article. Print server 701 connects to the printer through a serial port, parallel port, bus, network, USB, Ethernet or any communication technology.

I claim:

1. A method for creating a print image using a computer processing system, comprising:
retrieving a plurality of layouts from a first server; retrieving a plurality of images from at least one image server;
prompting a user to select a layout from one of the plurality of layouts, wherein each of the plurality of layouts is composed of at least one bounded area;
prompting the user to select at least one image from the plurality of images for placement in the at least one bounded area;
sending selected layout information, selected image information, and placement information to a print server, wherein the selected layout information corresponds to the layout selected by the user, wherein the selected image information corresponds to the at least one image selected by the user, and wherein the placement information corresponds to placement of the at least one image selected by the user in the layout selected by the user;
wherein the print server creates the print image according to the selected layout information, the selected image information and the placement information;
wherein the print image is printed on an article by a printer under instructions of the print server.

2. The method of claim 1, further comprising performing at least one image processing operation on the at least one image selected to fit corresponding bounded area.

3. The method of claim 1 wherein the first server is the same as the image server.

4. The method of claim 1 wherein the plurality of images are low resolution versions of images stored at the at least one image server.

5. The method of claim 1, wherein the plurality of images are comprised of a first group of images and a second group of images, wherein the first group of images are created by the user and the second group of images are not created by users.

6. The method of claim 5, wherein the second group of images are enabled for printing on the article when a consideration is received.

7. A method for printing a print image on an article using a computer processing system, comprising:
receiving selected layout information, selected image information and placement information, wherein the selected layout information corresponding to a layout selected, wherein the layout selected is composed of at least one bounded area;
wherein the selected image information corresponding to at least one image selected, and wherein the placement information corresponding to placement of the at least one image selected in the layout selected;
retrieving at least one high resolution image from at least one image server, wherein the at least one high resolution image corresponding to the at least one image selected;
creating a printing image based on the at least one high resolution image, the selected layout information and the placement information; and
sending instructions to a printer to print the print image on the article; wherein the at least one image selected is selected from a plurality of images.

8. The method of claim 7, further comprising not printing an omitting color.

9. The method of claim 8, wherein the omitting color is identical to background color of the article.

10. The method of claim 8, wherein the omitting color is within a pre-defined tolerance to a color.

11. The method of claim 8, wherein the omitting color is a color selected by an administrator of the computer processing system.

12. The method of claim 7, further comprising:
sending a plurality of layouts when receiving a request of retrieving layouts, wherein each of the plurality of layouts is composed of at least one bounded area.

13. The method of claim 7, wherein the plurality of images are retrieved from at the least one image server by sending a request to the at least one image server with authentication information.

14. The method of claim 7, wherein the article is a case for mobile electronic device and the size of the article is between 5 and 45 centimeters wide and between 10 and 50 centimeters long.

15. The method of claim 7, wherein the article is selected from a group consisting of a toy, an apparel item, a fashion accessory, a case for a cellular phone, a case for a tablet, a case for a laptop, a sticker, a cup, and a tumbler.

16. The method of claim 7, wherein the plurality of images are comprised of a first group of images and a second group of images, wherein the first group of images are created by the user and the second group of images are not created by the user.

17. The method of claim 16, wherein the second group of images are allowed to be printed on the article if a consideration is received.

18. A system for printing a print image on an article, comprising:
at least one network interface;
at least one processing unit; and
a storage medium comprising program instructions executable by the at least one processing unit for:
receiving selected layout information, selected image information and placement information, wherein the selected layout information corresponds to a layout selected, wherein the layout selected is composed of at least one bounded area;
wherein the selected image information corresponding to at least one image selected, and wherein the placement information corresponding to placement of the at least one image selected in the selected layout;
retrieving at least one high resolution image from at least one image server, wherein the at least one high resolution image corresponding to the at least one image selected;
creating a printing image based on the at least one high resolution image, the selected layout information and the placement information; and
sending instructions to a printer to print the print image on the article; wherein the at least one image selected is selected from a plurality of images.

19. The system of claim 18, the storage medium further comprising program instructions executable by the at least one processing unit for not printing an omitting color.

20. The system of claim 19, wherein the omitting color is identical to background color of the article.

21. The system of claim 19, wherein the omitting color is within a pre-defined tolerance to a color.

22. The system of claim 19, wherein the omitting color is a color selected by the administrator of the computer processing system.

23. The system of claim 18, the storage medium further comprising program instructions executable by the at least one processing unit for sending a plurality of layouts when receiving a request of retrieving layouts, wherein each of the plurality of layouts is composed of at least one bounded area.

24. The system of claim 18, wherein the plurality of images is retrieved from the at least one image server by sending a request to the at least one image server with authentication information.

25. The system of claim 18, wherein the article is a case for mobile electronic device and the size of the article is between 5 and 45 centimeters wide and between 10 and 50 centimeters long.

26. The system of claim 18, wherein the article is selected from the group consisting of a toy, an item of apparel, a fashion accessory, a case for a cellular phone, a case for a tablet, a case for a laptop, a sticker, a cup, and a tumbler.

27. The system of claim 18, wherein the plurality of images is comprised of a first group of images and a second group of images, wherein the first group of images are created by the user and the second group of images are not created by the user.

28. The system of claim 27, wherein the second group of images are allowed to be printed on the article if a consideration is received.
